(19) United States
(12) Patent Application Publication
(10) Pub. No.: US 2003/0110076 A1
(43) Pub. Date: Jun. 12, 2003

(54) Payment to user for access to user information by others

(76) Inventor: Laurence E. Holt, London (GB)

Correspondence Address: LAW OFFICES OF MICHAEL DRYJA, 704 228TH AVENUE NE, PMB 694, SAMMAMISH, WA, 98074, US

(21) Appl. No.: 09/683,292

(22) Filed: Dec. 10, 2001

(51) Int. Cl. G06F 17/60

(52) U.S. Cl. 705/14

(57) ABSTRACT

Paying users for access to their personal information by others is disclosed. Users register with an information provider. Personal information regarding the users is stored by the information provider, or at the users themselves. Organizations pay the information provider for access to the users' personal information. The information provider pays to each of these users a portion of the amount collected from the organization for access to their personal information.

### BACKGROUND OF INVENTION

This invention relates generally to personal and other types of user information, and more particularly to paying users for access to such information.

The Internet, and more specifically its worldwide web (“the web”), has become increasingly popular with consumers. Using web browser programs on their Internet-enabled computers, consumers have a wealth of information and services available to them. They can research new automotive purchases, download music, share photos, and do other sorts of activities.

To customize their web sites to individual consumers, organizations have begun to ask users to register with their sites. For instance, a sports-oriented web site may ask a user to indicate which sports the user follows the most, so that the site can then present web pages to the user that are related to these sports. Typically how this is accomplished is that the site, once the user has registered with it, stores a small file, called a “cookie,” on the user's computer. When the user accesses the site again, the site looks for this cookie, which contains the user's preferences.

Web sites also request and store more personal information regarding users. They may query users for their residential addresses, their sex, their age, and their income bracket. This information can then be used by the web sites to market goods and services to the users in a targeted manner. The information may also be aggregated, and sold to third parties, or analyzed to determine the type of user that visits a particular web site.

As a result of this information harvesting, users have begun to become concerned about their privacy being violated on the Internet. With the vast computing power available almost to any type of organization, it is easy to trade or sell collected personal information on a large number of users with other organizations. Users may at best be subjected to an onslaught of both physical and electronic junk mail. At worst, the users may find themselves the subject of identity theft, or find that the credit card information they shared with web sites has been used against their wishes.

Organizations also receive the personal information of consumers in other ways. Some businesses exist to collect and aggregate information on consumers, which is then packaged and sold to other organizations. A high-end women's apparel company may, for instance, wish to send catalogs to female consumers who live in certain zip codes, and have household incomes over $150,000. Such a company likely can find a business that can search a database for such consumers, and sell a mailing list to the company. This type of database querying and culling is known as data mining.

Data mining has also alarmed privacy advocates. Personal information of consumers, which many consumers believe they “own,” is increasingly exchanged and sold without their knowledge, and without them receiving any sort of compensation for this information. Since the advent of the Internet, more databases with such information are more easily accessible. Like the case of web site registration, data mining also portends the user being deluged with junk mail, or worse.

For these and other reasons, therefore, there is a need for the present invention.

### SUMMARY OF INVENTION

The invention relates to paying users for access to their personal information by others. In a method of one embodiment of the invention, users register with an information provider. The information provider stores personal information regarding the users. An organization purchases from the information provider a desired sub-set of the personal information, regarding at least some of the users. The information provider pays to each of these users a portion of the amount collected from the organization for access to their personal information.

In a method of another embodiment of the invention, a user registers with an information provider, which centrally stores personal information of the user. The user stores a user identifier. An organization requests at least some of the personal information of the user from the information provider based on the user identifier that it might have retrieved from the user. Upon verifying that the organization has subscribed to receive such information, the information provider provides the organization with the requested information. The organization pays the information provider for access to this personal information, which in turn pays the user a portion of the amount collected from the organization.

In a method of still another embodiment of the invention, a user registers with an information provider, which encrypts personal information of the user. The personal information is stored locally at the user. An organization subscribes with the information provider for access to a decryption key for decryption of the user's personal information. The organization requests at least some of the personal information from the user, which provides the organization with this information as encrypted. The organization decrypts the information, and pays the information provider for access to the personal information. The information provider pays the user a portion of the amount collected from the organization.

The invention provides for advantages over the prior art. Foremost, users are paid for providing access to their personal information. In the method of the first embodiment, the users may preferably specify the price for access to particular aspects of their personal information, and may also specify whether they wish to be individually identifiable when such information is divulged, or whether they wish to have their information aggregated so that they cannot be identified. In the methods of the other embodiments, the user only has to register once, with the information provider, and not with all the individual web sites he or she may visit. Furthermore, the user receives payment for providing access to his or her personal information to such web sites. Still other advantages, aspects, and embodiments of the invention will become apparent by reading the detailed description that follows, and by referencing the accompanying drawings.

### BRIEF DESCRIPTION OF DRAWINGS

FIG. 1 is a diagram of an example system topology, in conjunction with which embodiments of the invention can be implemented.

FIG. 2 is a flowchart of a data mining method according to an embodiment of the invention, in which users receive payment in exchange for releasing personal information to organizations.

FIG. 3 is a flowchart of a registration method according to an embodiment of the invention, in which users receive payment in exchange for registration with organizations, such as with their web sites.

FIG. 4 is a flowchart of a more particular registration method according to an embodiment of the invention, in which the personal information of a user is stored centrally at a provider.

FIG. 5 is a flowchart of a more particular registration method according to an embodiment of the invention, in which the personal information of a user is stored locally on a device of the user.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

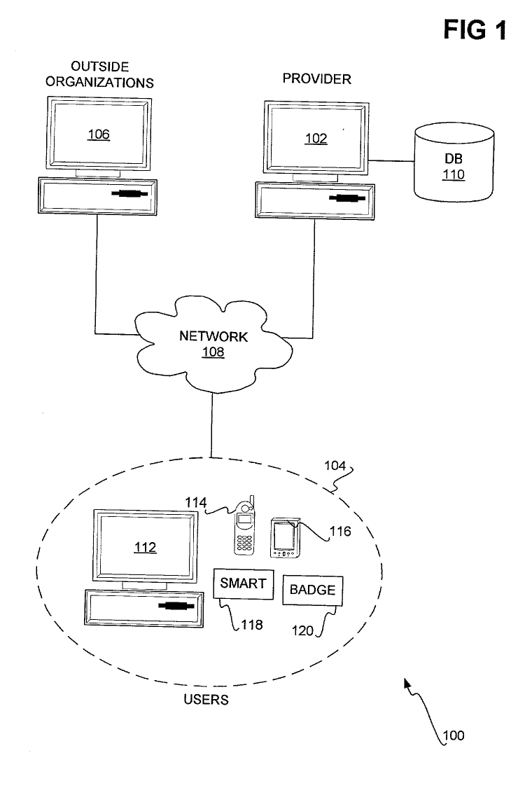

FIG. 1 shows a topology of an example system 100 that can be used in conjunction with embodiments of the invention. The system 100 includes a provider 102, users 104, and outside organizations 106, which are preferably communicatively coupled to one another through a network 108. The network 108 may be one or more of the Internet, intranets, extranets, wide-area networks (WAN's), local-area networks (LAN's), telephone networks, including cellular and mobile phone networks, as well as other types of networks. The provider 102 typically has a database 110 on which personal information regarding the users 1 04 can be stored in at least some embodiments of the invention. The outside organizations 106 pay the provider 102 for access to the personal information of the users 104, after the users 104 have registered with the provider 102. The provider 102 in turn pays the users a portion of the payment collected from the outside organizations 106.

The users 104 may have a number of different types of devices that they use. Such devices can include computers 112, such as laptop computers, notebook computers, desktop computers, and so on. The devices may also include cellular and mobile phones 114 and personal-digital assistant (PDA) devices 116. The devices may include cards 118, such as smart cards, magnetic-stripped cards, and so on, as well as badges 120. The users 104 may also use other types of devices. When reference is made to the user storing information locally, this means that the information is stored locally at one of the user's devices. Furthermore, when reference is made to the provider 102 storing information centrally, this means that the information is stored by the provider at a device like the database 110.

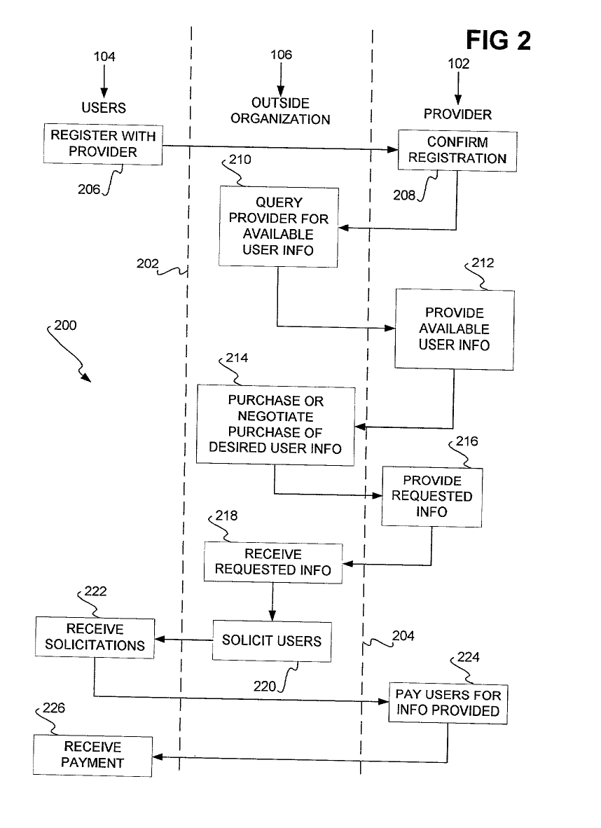

FIG. 2 shows a method 200 according to an embodiment of the invention. The method 200 is particularly a data mining method, in that personal information of the users 104 is collected by the information provider 102, and then is aggregated for querying by the outside organizations 1 06, which subsequently pay for access to desired information. Parts of the method 200 are performed by the users 104, the outside organizations 106, and the information provider 102, as the method 200 is separated into columns by the dotted lines 202 and 204.

The users first register with the information provider (206), which confirms such registration (208). Registration entails the users providing personal information to the information provider, which then stores this information. The users may also indicate a number of different preferences as to how their information is accessible by the outside organizations. For instance, they may indicate whether they wish to be personally identifiable by information divulged to the outside organizations. They may also separate information into parts that they do not mind being personally identifiable by its divulgence, and parts that they wish to not be personally identifiable by its divulgence.

For example, a user may provide his or her full legal name, residential address, telephone number, income bracket, and interests. The user may allow any of this information to be divulged in a way that does not personally identify him or her. For example, an outside organization may be interested in the number of users who live in certain zip codes, have certain interests, and have income over a certain amount, for demographical analysis purposes. The aggregation of all the users in such a way does not divulge any user's personal identity. The user may also allow his or her name, address, and interests be divulged in a personally identifiable manner, but not his or her telephone number or income bracket. An outside organization can thus learn of the user's identity as someone who enjoys sports, for instance, but not the user's income bracket or telephone number.

The users may also indicate in the registration process the price range, including specific prices, at which they are willing to sell access to certain parts of their personal information. Aggregated information that does not personally identify the users may, for instance, be sold at a lower price than information that personally identifies the users. Furthermore, the price ranges specified by the users may allow for a certain degree of negotiation to take place between the outside organizations and the users, when the outside organizations request information about them.

The outside organizations thus can query the information provider for the types of information regarding users that is available (210). The information provider provides the types of personal information available (212), and the outside organizations purchase or negotiate the purchase of desired personal information regarding the users (214). The negotiation is accomplished with the information provider acting as a proxy for the users. The negotiation yields purchase of personal information when a price or price range is reached that is acceptable to the outside organization, the information provider, and the relevant users.

The outside organizations may purchase aggregated information that does not identify any of the users, or information that personally identifies the users. Typically, the outside organizations do not purchase all the information available regarding all the users, but a desired subset of information regarding a desired subset of the users. For example, an outside organization may be interested in the names and addresses of users who live in snowy climates, as identified by zip code, and have at least one car, so that the organization can solicit these users with snow tire offers. That is, more generally, the outside organizations are interested in mining the data collected by the information provider regarding the users, and not as interested in seeing all the personal information regarding all the users.

The information provider thus provides the requested information to the outside organization (216), which receives the information (218), and utilizes the information received in some way. As shown in the method 200 of FIG. 2, the outside organization specifically solicits the users regarding which it has received information (220), which then receive these solicitations (222). However, other sorts of uses of the received personal information are encompassed by the invention as well. Aggregated information that does not personally identify users on an individual basis, for instance, may be used for analysis purposes, and not for soliciting the users.

Ultimately, the information provider pays the users for the information it provided to the outside organizations (224). The users then receive this payment (226). The amount paid is a portion of the amount collected by the information provider. Users receive payment based on the type and degree of information regarding them that were divulged to outside organizations. Payment may be made in a monetary or non-monetary manner. For instance, on a quarterly or other basis, the users may have the money due them deposited into their bank accounts by the information provider, or checks may be cut and sent to the users. As another example, the user may receive proprietary points, comparable to airline frequent flyer miles.

It is noted that preferably the outside organizations pay for access to the personal information of the user, and not necessarily for presenting advertisements to the user in a non-customized fashion. The user registers with the information provider, where the information provider is preferably his or her agent. An outside organization pays for access to the personal information of the user, and then can utilize the information in a number of different ways. The organization may customize web pages shown to the user; the organization may fashion custom solicitations particular to the user, based on his or her personal information; and so on. This is in distinction with the prior art, where a user may sign up to be paid based on the number of ads he or she views, be they email ads, banner ads, and so on. Such ads are not customized based on the user's personal information, and an organization in such instance is paying for the ability to market a large number of users one or more given ads, and not for access to the personal information of users, as in the preferred embodiment.

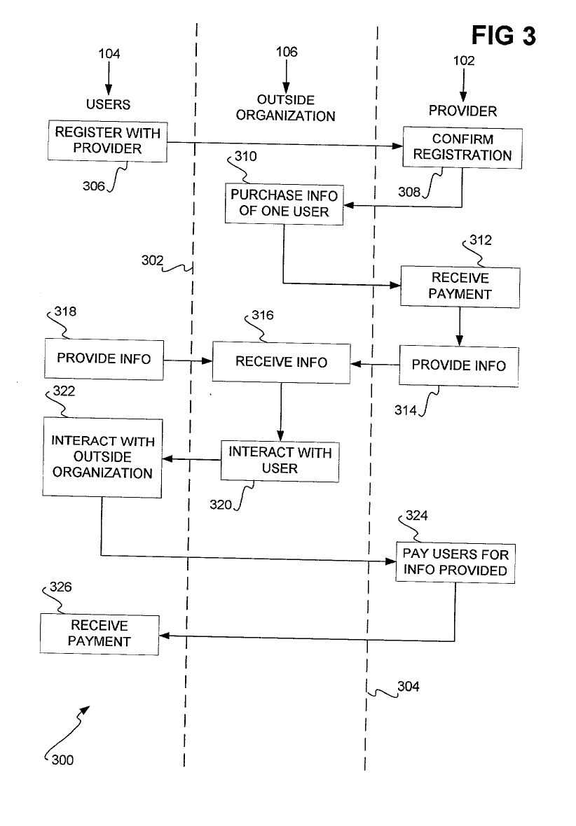

FIG. 3 shows a method 300 according to another embodiment of the invention. The method 300 is a general registration method, in that a user registers with the information provider 1 02, and subsequent access by outside organizations 106 to the user's personal information, for web site registration and other purposes, is managed by the provider 102. The outside organizations 106 pay for access to this information, and the provider 102 returns some of the money collected back to the users 104. Parts of the method 300 are performed by the users 104, the outside organizations 106, and the provider 102, as the method 300 is separated into columns by the dotted lines 302 and 304. Furthermore, parts of the description of the method 200 of FIG. 2 are applicable to the method 300, insofar as payment and information querying and requesting, for example, are concerned.

The user first registers with the information provider (306), which confirms such registration. The personal information of the user is stored either at the user, or at the information provider. The information provider may provide the user with a user identifier, which may be selected by the user or the information provider. An outside organization then desires to purchase the information of one of the users (310). For example, the user may have browsed to the organization's web site, and may desire to use a quick registration feature of the site that links back to the information provider. The organization may pay a monthly subscription for access to the information provider's service, or may pay for each user for which it retrieves information. The provider receives payment from the outside organization (312).

The outside organization is then enabled to receive information regarding the user (316). The information may be provided by either the information provider (314), or by the user him or herself (318), as will be more particularly described later in the detailed description. The outside organization then utilizes this information. For instance, the organization may interact with the user based on this information (320), such that the user interacts with the organization (322). As an example, the outside organization may learn the user's interests, and tailor the web pages of its web site displayed to the user accordingly. Ultimately, the provider pays the user for the information that was provided to the outside organization (324), which is collected by the user in either a monetary or non-monetary manner (326).

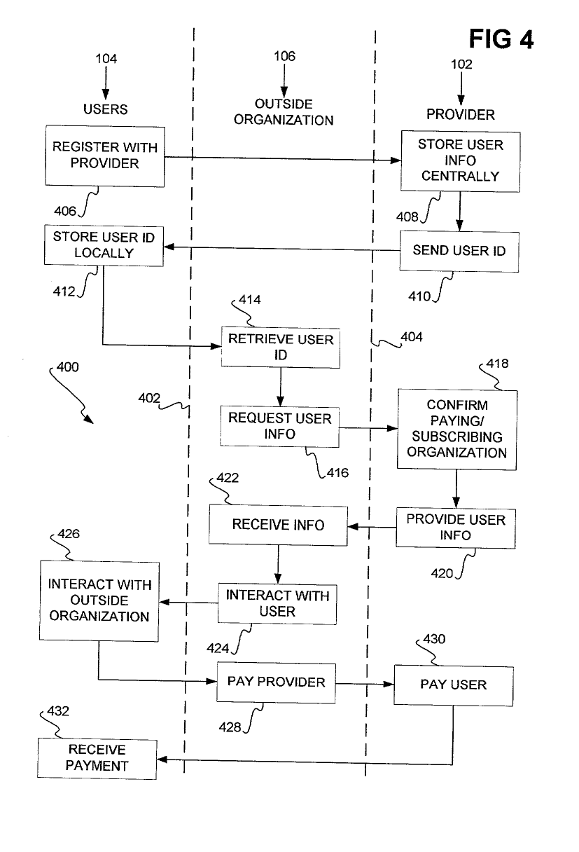

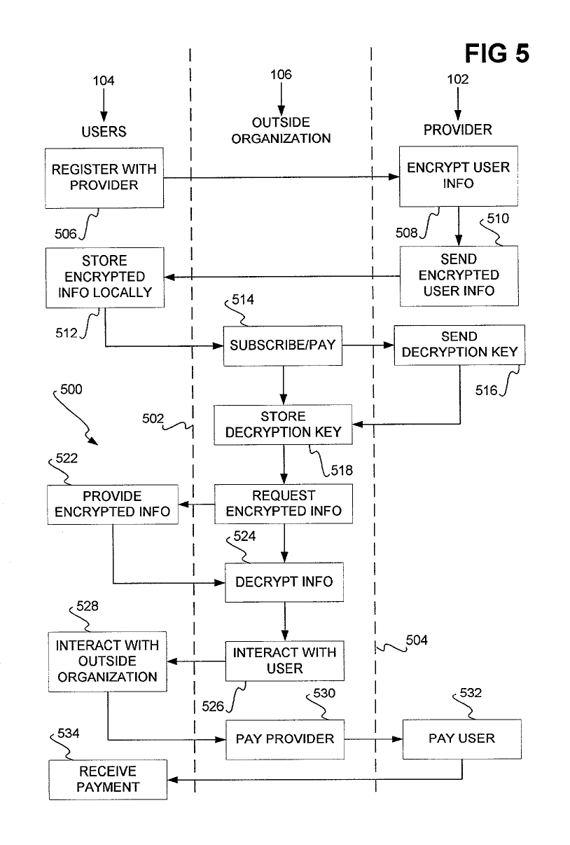

The registration method 300 can be particularly one in which the personal information of the user is stored centrally at the information provider, or stored locally at each individual user. The former approach is specifically described with reference to the method 400 of FIG. 4, whereas the latter approach is specifically described with reference to the method 500 of FIG. 5. Referring first to FIG. 4, parts of the method 400 are performed by the users 104, the outside organizations 106, and the provider 102, as the method 400 is separated into columns by the dotted lines 402 and 404. Furthermore, parts of the description of the methods 200 and 300 of FIGS. 2 and 3 are applicable to the method 400, insofar as payment and information querying and requesting, for example, are concerned.

First, the user registers with the information provider (406). The personal information disclosed by the user during the registration process is stored centrally at the information provider (408). A user identifier is then sent to the user (410), which may be selected by the user him or herself, or generated by the information provider. The user identifier is stored locally at the user (412). For example, it may be stored in a small file known as a “cookie,” or as a file that is accessible only to a small program installed in the browser, such as a plug-in, an ActiveX control, or another type of program. An outside organization retrieves this user identifier (414) in a variety of different instances. For example, when a user browses to the outside organization's web site, the web site may automatically retrieve the user identifier from the user.

The outside organization requests at least some of the personal information of the user from the information provider (416), on the basis of this user identifier. The information provider confirms or verifies that the outside organization is a paying or subscribing organization, or otherwise is entitled to access this information (418). As in other embodiments, the outside organization may be requesting only some of the user's personal information, and the user may place limits on how the information is divulged to the outside organization. That is, the outside organization typically requests a desired sub-set of the personal information regarding the user. Assuming that the outside organization is entitled to the information, the information provider provides this information to the outside organization (420), which receives the information (422).

The outside organization subsequently utilizes the information. For example, as shown in the method 400, the outside organization may interact with the user (424) based on the personal information regarding the user it received, where the user likewise interacts with the outside organization (426). In the case of a web site for the outside organization, the site may tailor web pages particular to the interests of the user, for example. As another example, when the user is making a purchase from the outside organization, credit card and other information for the purchase may be automatically filled in for the user, so that he or she does not have to reenter the information on every site the user visits. Likewise, when the user is registering with a web site, personal information regarding the user, such as his or her address, phone number, and so on, may be automatically filled in so that the user does not have to continually reenter the information on each site he or she visits.

The outside organization pays the provider for access to the personal information on the user (428), on a per-individual basis, a monthly complete-access basis, or on another basis. The information provider in turn pays the user a portion of the amount collected from the outside organization for access to the user's personal information (430). The user then receives such payment (432), in a monetary or non-monetary manner, and so on.

Referring now to FIG. 5, the method 500 provides a registration method similar to that of the method 400. However, whereas the method 400 has the personal information of the user centrally stored by the information provider itself, the method 500 has the personal information of the user individually stored at the user him or herself, in an encrypted manner. Parts of the method 500 are performed by the users 104, the outside organizations 106, and the provider 102, as the method 500 is separated into columns by the dotted lines 502 and 504. The method 500 is substantially similar to the method 400, and description of the method 500 is made in detail only where it diverges from the method 400.

First, the user registers with the information provider (506). Personal information is disclosed to the information provider, which encrypts this information (508). Encryption may be performed based on an encryption key, for example, that combines identity of the user such as a user identifier with a provider-generated key. The provider subsequently sends the user the encrypted information (510), where it is stored locally at the user (512). An outside organization initially subscribes or pays for access to the personal information of users (514), such that the organization has access to the decryption key.

Besides the decryption key, the user identifier of the user may also be required to decrypt the encrypted personal information of the user. That is, the identifier may be combined with the general decryption key to specifically decrypt the user's information. However, this is not required, and alternatively, the general decryption key may be all that is needed to decrypt the personal information of the user. As shown in the method 500, the information provider sends the decryption key to the outside organization (516) which stores the key (518). However, alternatively the outside organization only has access to the decryption key, and is not provided the key itself. For instance, in such an alternative embodiment, the outside organization must send the encrypted information to the information provider for decryption, which decrypts the information and sends it back to the outside organization.

The outside organization requests at least some of the personal information of the user (520), specifically some of the encrypted personal information of the user. The user provides this encrypted information (522), as well as, for instance, the user identifier, if it is necessary for decryption of the encrypted information. The outside organization then decrypts the encrypted information (524). This can be accomplished, for instance, by using the decryption key stored by the organization in conjunction with the user identifier. Alternatively, the organization may decrypt the information by sending it to the information provider along with, for example, the user identifier, and the provider returns the decrypted information.

The outside organization then utilizes the personal information, in manners that have been specifically described. For instance, in the method 500, the outside organization interacts with the user (526), which likewise interacts with the organization (528), on the basis of the personal information divulged to the organization. Ultimately, the outside organization pays the provider for access to the personal information of the user (530). The information provider then pays the user a portion of the amount collected from the outside organization (532), and the user receives payment in a monetary or non-manner manner (534).

The local storage of personal information of the method 500 of FIG. 5 may be desirable where the user is storing the information on a device not readily accessible to the information provider, and where the outside organization may not also readily communicate to the information provider. For example, in a conference, the user may have a badge or a credit card that stores his or her personal information. To register with various organizations, to get on their mailing lists, and so on, the outside organization may merely need to read the information from the badge or credit card, and decrypt it. Instantaneous communication with the information provider may not be needed in this scenario for the organizations to receive the personal information of the users. For example, the decryption key may expire after a certain period of time, and be event specific, such that it can be used off-line without compromising security of the key, since it will expire.

The above embodiment described in conjunction and with reference to FIG. 5 can be varied or extended in varying ways without departing from the invention. In one embodiment, to ensure that the organization accesses only the information that it has paid for, there may be different encryption and/or decryption keys for various parts of the information (or for different users), or the user may log what information has been accessed by the organization. The user then periodically logs in with the information provider to indicate the information that has been accessed.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
registering by a plurality of users with an information provider, where personal information regarding the plurality of users is stored by the information provider;
purchasing by an organization from the information provider a desired sub-set of the personal information regarding a sub-plurality of the plurality of users; and,
paying by the information provider to each of the sub-plurality of the plurality of users a portion of an amount collected by the information provider from the organization for access to the desired sub-set of the personal information regarding the user.

2. The method of claim 1, wherein registering the plurality of users with the information provider comprises indicating by the plurality of users whether they wish to be personally identifiable to a plurality of organizations including the organization.

3. The method of claim 1, wherein registering the plurality of users with the information provider comprises indicating by the plurality of users parts of the personal information that they wish to hide from a plurality of organizations including the organization on an individually identifiable basis, and parts of the personal information that they wish to reveal from the plurality of organizations on the individually identifiable basis.

4. The method of claim 1, wherein registering the plurality of users with the information provider comprises indicating by the plurality of users price ranges for which they are willing to divulge parts of the personal information to a plurality of organizations including the organization.

5. The method of claim 1, wherein purchasing by the organization from the information provider the desired sub-set of the personal information regarding the sub-plurality of the plurality of users comprises purchasing aggregated information not individually identifying any of the sub-plurality of the plurality of users.

6. The method of claim 1, wherein purchasing by the organization from the information provider the desired sub-set of the personal information regarding the sub-plurality of the plurality of users comprises purchasing information individually identifying each of the sub-plurality of the plurality of users.

7. The method of claim 1, wherein purchasing by the organization from the information provider the desired sub-set of the personal information regarding the sub-plurality of the plurality of users comprises negotiating between the organization and the information provider a price range for the desired sub-set of the personal information acceptable to the organization, the information provider, and the sub-plurality of the plurality of users.

8. The method of claim 1, wherein paying by the information provider to each of the sub-plurality of the plurality of users the portion of the amount collected by the information provider from the organization for access to the desired sub-set of the personal information regarding the user comprises paying by the information provider to each of the sub-plurality of the plurality of users a non-monetary amount of units corresponding to and representing the portion of the amount collected by information provider from the organization for access to the desired sub-set of the personal information regarding the user.

9. The method of claim 1, wherein paying by the information provider to each of the sub-plurality of the plurality of users the portion of the amount collected by the information provider from the organization for access to the desired sub-set of the personal information regarding the user comprises paying by the information provider to each of the sub-plurality of the plurality of users a monetary amount corresponding to and representing the portion of the amount collected by information provider from the organization for access to the desired sub-set of the personal information regarding the user.

10. The method of claim 1, further comprising utilizing the desired sub-set of the personal information regarding the sub-plurality of the plurality of users by the organization.

11. A method comprising:
registering by a user with an information provider, where personal information of the user is stored centrally by the information provider;
storing a user identifier at the user;
requesting a desired sub-set of the personal information of the user by an organization to the information provider based on the user identifier as retrieved from the user;
upon verifying by the information provider that the organization is a subscribing organization, providing the organization with the desired sub-set of the personal information by the information provider;
paying by the organization to the information provider for access to the desired sub-set of the personal information; and,
paying by the information provider to the user a portion of an amount collected by the information provider from the organization for access to the desired sub-set of the personal information regarding the user.

12. The method of claim 11, further comprising, prior to storing the user identifier at the user, sending the user identifier by the information provider to the user.

13. The method of claim 11, further comprising, after storing the user identifier at the user, retrieving by the organization the user identifier.

14. The method of claim 11, further comprising, interacting by the organization with the user based on the desired sub-set of the personal information received by the organization.

15. The method of claim 11, wherein paying by the information provider to the user the portion of the amount collected by the information provider from the organization for access to the desired sub-set of the personal information regarding the user comprises paying by the information provider to the user one of a monetary and non-monetary amount corresponding to and representing the portion of the amount collected by the information provider from the organization for access to the desired sub-set of the personal information regarding the user.

16. A method comprising:
registering by a user with an information provider, where personal information of the user is encrypted by the information provider;
storing locally at the user the personal information of the user as encrypted;
subscribing by an organization with the information provider for access to a decryption key for decrypting the personal information of the user;
requesting a desired sub-set of the personal information of the user by the organization to the user;
providing the organization with the desired sub-set of the personal information as encrypted by the user, the organization decrypting the desired sub-set of the personal information;
paying by the organization to the information provider for access to the desired sub-set of the personal information; and,
paying by the information provider to the user a portion of an amount collected by the information provider from the organization for access to the desired sub-set of the personal information regarding the user.

17. The method of claim 16, wherein subscribing by the organization with the information provider for access to the decryption key comprises the organization receiving from the information provider the decryption key for storage by the organization for subsequent decryption of the personal information of the user.

18. The method of claim 16, wherein the organization decrypting the desired sub-set of the personal information comprises the organization passing the desired sub-set of the personal information as encrypted to the information provider for decryption and receiving back from the information provider the desired sub-set of the personal information as decrypted.

19. The method of claim 16, further comprising, interacting by the organization with the user based on the desired sub-set of the personal information received by the organization.

20. The method of claim 16, wherein paying by the information provider to the user the portion of the amount collected by the information provider from the organization for access to the desired sub-set of the personal information regarding the user comprises paying by the information provider to the user one of a monetary and non-monetary amount corresponding to and representing the portion of the amount collected by the information provider from the organization for access to the desired sub-set of the personal information regarding the user.
